(19) United States
(12) Patent Application Publication
(10) Pub. No.: US 2013/0305627 A1
(43) Pub. Date: Nov. 21, 2013

(54) TELESCOPIC SUPPORT FOR AN EXPANDABLE SHELTER

(71) Applicants: Richard S. Pike, Saint Johnsbury, VT (US); Philip T. Cantin, Guildhall, VT (US); Rick A. Cochran, Saint Johnsbury, VT (US)

(72) Inventors: Richard S. Pike, Saint Johnsbury, VT (US); Philip T. Cantin, Guildhall, VT (US); Rick A. Cochran, Saint Johnsbury, VT (US)

(21) Appl. No.: 13/894,752

(22) Filed: May 15, 2013

Related U.S. Application Data
(60) Provisional application No. 61/647,368, filed on May 15, 2012.

(51) Int. Cl. E04B 1/343; F16B 7/10

(52) U.S. Cl. CPC E04B 1/34305; F16B 7/10
USPC 52/79.5; 403/52

(57) ABSTRACT

A telescopic support assembly including tube assemblies and bearing assemblies. The tube assemblies are arranged telescopically from a largest cross section rear tube assembly to a smallest cross section front tube assembly. The bearing assemblies include a non-roller bearing for each tube assembly other than the front tube assembly. Each bearing assembly is configured to present a surface of the non-roller bearing at the bottom interior of a tube assembly, proximate the front of the tube. Some embodiments include a drive assembly for extending and retracting the telescopic support assembly.

### CROSS-REFERENCE TO RELATED APPLICATIONS

This application claims priority from U.S. Provisional Patent Application No. 61/647,368 entitled “TELESCOPIC SUPPORT FOR AN EXPANDABLE SHELTER SYSTEM”, filed on May 15, 2012.

### BACKGROUND

1. Field of Invention

The present application relates generally to expandable shelter systems, and more particularly, to telescopic support for expandable shelter systems.

2. Related Art

Portable shelters are often used to provide temporary facilities for various purposes, such as military, civilian, and medical applications. Such portable shelters may be used to supplement permanent structures when additional space is desired, or to provide new facilities for temporary use, such as the provision of emergency response services after a disaster. Motorized vehicles, such as vans, buses, and recreational vehicles (RVs), etc., may be used as portable shelters under certain circumstances. While these types of motorized vehicles are able to transport themselves to a desired location, they may provide limited interior space for the intended use, while also being relatively expensive. Some portable shelters are configured to have the size and shape of a standard International Organization for Standardization (ISO) intermodal shipping container. In this way, such shelters may be shipped by commercial means, such as by railway, boat, or aircraft, including military aircraft.

The floor space of conventional portable shelters is limited by the fixed external dimensions of the shelter. Expansion modules akin to “slide out” sections of RVs have been used to increase the operational floor space enclosed by a shelter. Such modules, also known as “expandable components,” may be hydraulically or mechanically driven to extend and retract from the shelter on support beams. A fully loaded expandable component can approach 5000 lbs.

Such support beams are known to incorporate heavy load bearing, dynamic, metal rolling element bearings (also referred to herein as “metal roller bearings”), e.g., using captive metal ball bearings or needle bearings.

### SUMMARY

Embodiments of the disclosed technology include telescopic support assemblies. Each telescopic support assembly includes tube assemblies and one or more bearing assembly. The tube assemblies are arranged telescopically from a largest cross section rear tube assembly to a smallest cross section front tube assembly. Each bearing assembly includes a non-roller bearing. In some embodiments, the bearing assembly is configured to present a surface of the non-roller bearing at the bottom interior of a tube assembly, proximate the front of the tube assembly. In some embodiments, the bearing assembly extends into the interior of the tube assembly through a hole in the bottom of the tube assembly. In some embodiments the non-roller bearing is a self-lubricating engineering plastic. In some embodiments, the self-lubricating engineering plastic is a nylon plastic containing a lubricant powder. In some embodiments, the lubricant powder is molybdenum disulfide. In some embodiments the telescopic support does not include roller bearings.

Embodiments of the disclosed technology also include telescopic support assemblies including a main beam subassembly formed from the above-described elements, along with a drive assembly operable to telescopically extend and retract the main beam subassembly. In some embodiments the drive assembly is a powered drive assembly. In some embodiments the drive assembly is hydraulically powered.

Embodiments of the disclosed technology also include shelters comprising a shelter body having a shelter body perimeter, and at least one telescopic support assembly as variously described above. In some of those embodiments, each telescopic support assembly can have a retracted configuration and a plurality of extended configurations. Each telescopic support assembly can be attached to the shelter such that in at least one extended configuration, the telescopic support assembly extends beyond the shelter body perimeter.

### BRIEF DESCRIPTION OF THE DRAWINGS

Embodiments of the disclosed technology are described below with reference to the attached drawings, in which:

FIG. 1A is a perspective view of an embodiment of a power telescopic support assembly;

FIG. 1B is a perspective view of a main beam subassembly of the telescopic support assembly of FIG. 1A;

FIG. 1C is a perspective view of a drive assembly of the telescopic support assembly of FIG. 1A;

FIG. 2 illustrates front, left side, top, and bottom views of a rear tube assembly of a telescopic support assembly, along with bearing plates associated therewith, in accordance with the present technology;

FIG. 3 illustrates front, left side, top, and bottom views of a middle tube assembly of the telescopic support assembly, along with other features associated therewith, in accordance with the present technology;

FIG. 4 illustrates front, left side, top, and bottom views of a front tube assembly of the telescopic support assembly, along with other features associated therewith, in accordance with the present technology;

FIG. 5 illustrates a bearing assembly of a telescopic support of the present technology; and

FIG. 6 illustrates telescopic support assemblies applied to a shelter configured as a fifth wheel trailer.

The drawings are intended to illustrate aspects of the technology, and as such, are not necessarily to scale and may omit aspects well know to those of skill in the art and aspects not relevant to the disclosed features.

### DETAILED DESCRIPTION

Various factors can cause metal roller bearings used in supports for shelters to fail or to be disadvantageous. Typical limits to the lifetime of a metal roller bearing include abrasion from the introduction of contaminants (a common factor for supports exposed to the environment), fatigue from repeated loading and unloading, and degradation of the metal roller bearing from rust caused by moisture. Further metal roller bearing may comprise bearing races of complex shape, making them difficult and expensive to manufacture. Some metal roller bearing assemblies require routine addition of lubricants, while others are factory sealed, requiring no further maintenance for the life of the mechanical assembly. Although seals are appealing, they increase friction, and in a permanently-sealed bearing the lubricant may become contaminated by hard particles, such as steel chips from the race or bearing, sand, or grit that gets past the seal. Contamination in the lubricant is abrasive and greatly reduces the operating life of the bearing assembly.

Embodiments of the technology disclosed herein provide a telescopic support on solid, non-rolling, static low friction surfaces, i.e., “non-roller bearings.” “Low friction” refers to a low coefficient of friction (COF). COF is a measure of resistance to sliding of one surface over another, and can be measured in accordance with ASTM D 3702 promulgated by the American Society of Testing and Materials. The results of COF measurement in accordance with ASTM D 3702 do not have a unit of measure, since COF is the ratio of sliding force to normal force action on two mating surfaces. COF values are useful to compare the relative “slickness” of various materials, usually run un-lubricated over or against polished steel.

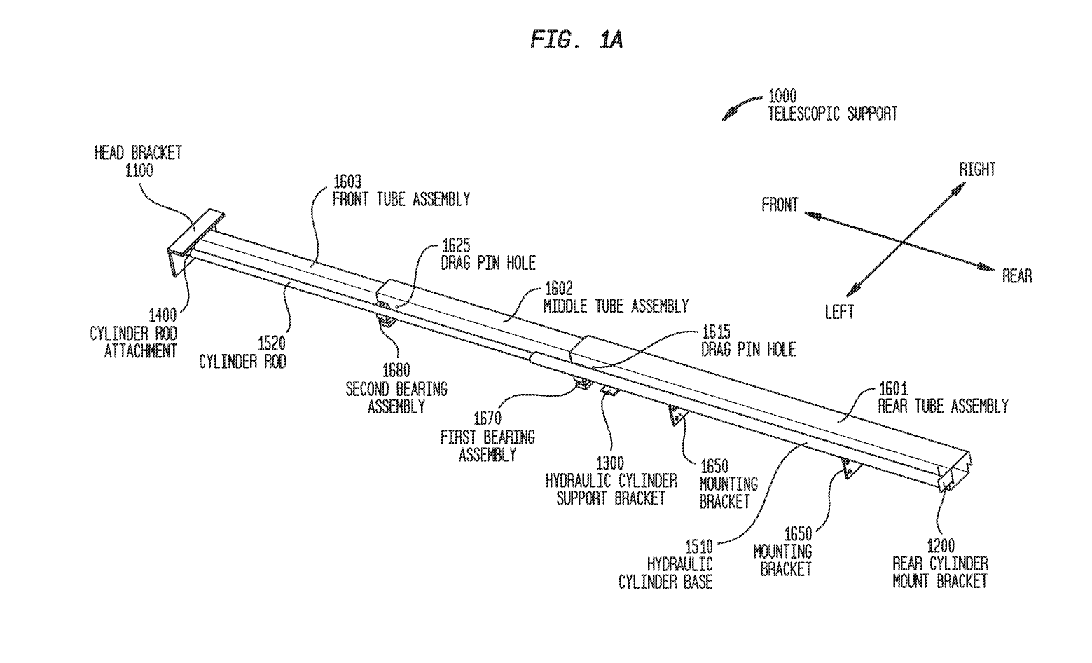

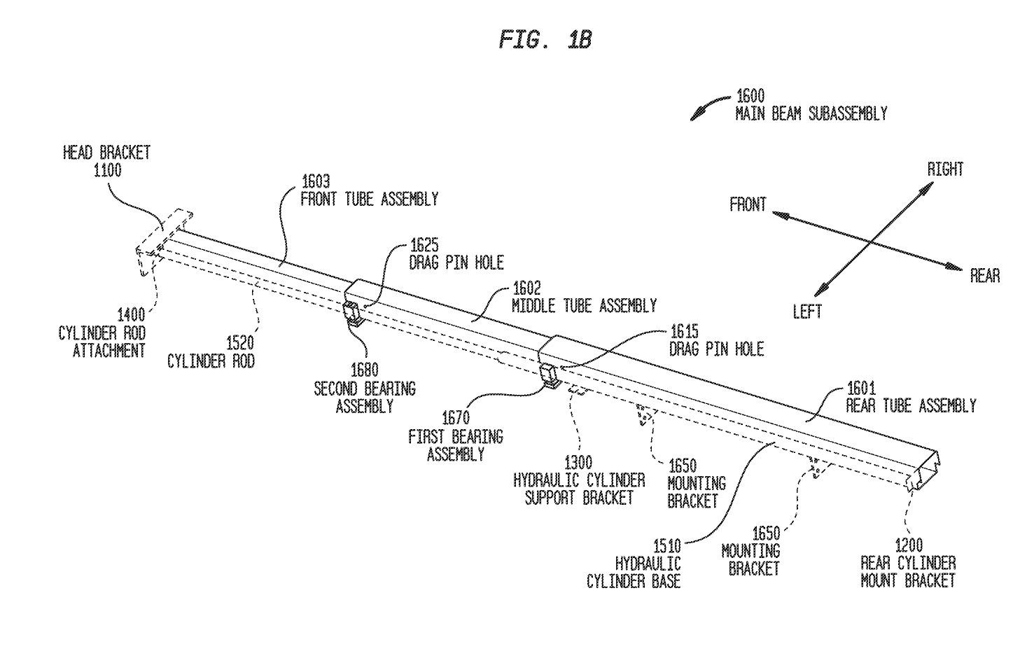

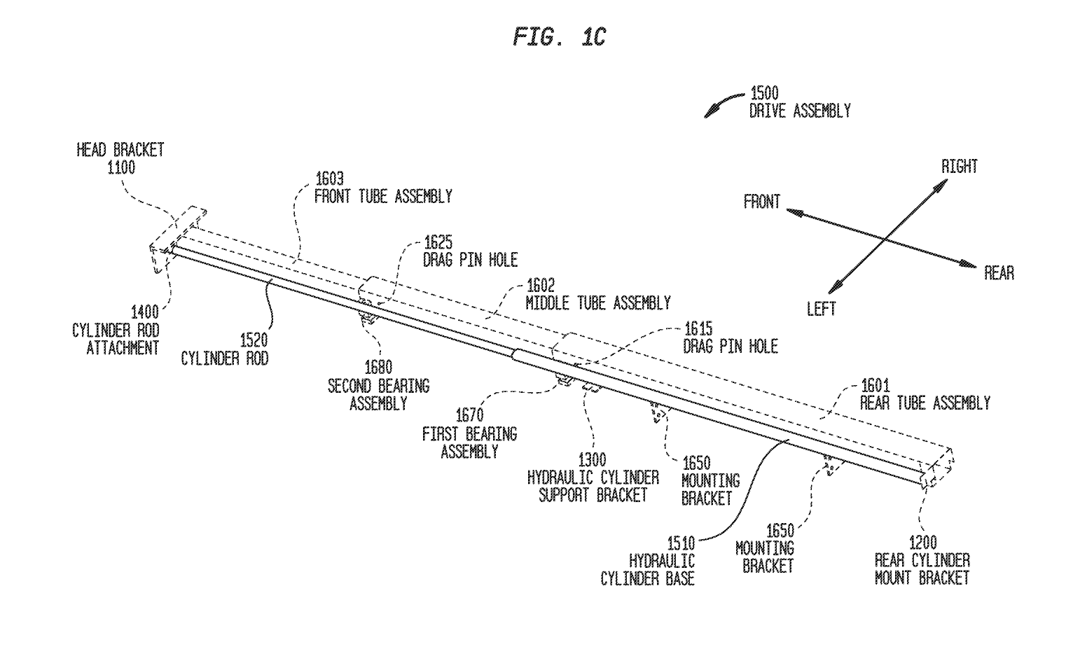

FIG. 1A is a perspective view of an embodiment of a power telescopic support 1000. An orientation key defining the front, rear, right, and left directions as used in this disclosure is also shown. The power telescopic support 1000 includes a telescopic main beam subassembly (“main beam”) 1600 (shown in FIG. 1B) comprising a rear tube assembly 1601, a middle tube assembly 1602, a front tube assembly 1603, first bearing assembly 1670, and second bearing assembly 1680. The illustrated power telescopic support 1000 also includes a drive assembly 1500 (shown in FIG. 1C) situated to the left of the main beam 1600, and comprising cylinder base 1510 and cylinder rod 1520. In other embodiments of the power telescopic support 1000, the drive assembly 1500 can be situated at other positions relative to the main beam 1600, e.g., right of the main beam 1600, under the main beam 1600, and within the main beam 1600. In some embodiments of the technology, the drive assembly 1500 is within and coaxial with the main beam 1600. Such embodiments are advantageous in circumstances where space is limited, where additional environmental protection is sought for the drive assembly 1500, and where the coaxial arrangement reduces the likelihood of jamming between the main beam 1600 and drive assembly 1500. The drive assembly 1500 of FIG. 1 is a hydraulic cylinder assembly comprising a cylinder base 1510 and a cylinder rod 1520. In some embodiments, two drive assemblies 1500 can be used. The drive assembly 1500 is terminated at the front end by a cylinder rod attachment 1400.

The illustrated cylinder base 1510 and cylinder rod 1520 of the drive assembly 1500, along with hydraulic cylinder drive components (not shown) are part of a double acting telescopic hydraulic cylinder, operable to extend and retract the power telescopic support 1000. In some embodiments, the telescopic hydraulic cylinder can be single stage (one rod); while in others, the telescopic hydraulic cylinder can have three or more stages. In some embodiments, plunger cylinders and differential cylinders can be used. In applications where multiple telescopic supports, e.g., power telescopic support 1000, are used to extend and retract a load, the drive assembly telescopic hydraulic cylinder can be part of a rephasing cylinder. In a rephasing cylinder, two or more cylinders are plumbed in series or parallel, with the bores and rods sized such that all rods extend and/or retract equally when flow is directed to the first, or last, cylinder within the system. In some embodiments, other means (both powered and manual) of extending and retracting the telescopic support assembly can be used, e.g., chain drive, screw drive.

The main beam 1600 and the drive assembly 1500 are connected at the front of the power telescopic support 1000 by a head bracket 1100, and are connected at the rear of the power telescopic support 1000 by a rear cylinder mounting bracket 1200. The cylinder base 1510 is supported by a cylinder support bracket 1300 attached near the front end of the rear tube assembly 1601. The illustrated power telescopic support 1000 includes a bracket pair 1650 for mounting the telescopic support 1000 to a shelter, from which the telescopic support 1000 (and the load that it carries, such as a shelter expandable component) can be extended and retracted. In other embodiments, the rear tube assembly 1601 is attached to the shelter in other fashions such as straps, and welding. Also illustrated in FIG. 1A, and described in greater detail below, are bearing assemblies 1670 and 1680 that support extension of middle tube assembly 1602 from the rear tube assembly 1601, and support extension of the front tube assembly 1603 from the middle tube assembly 1602, respectively, on solid, non-rolling, static low friction surfaces.

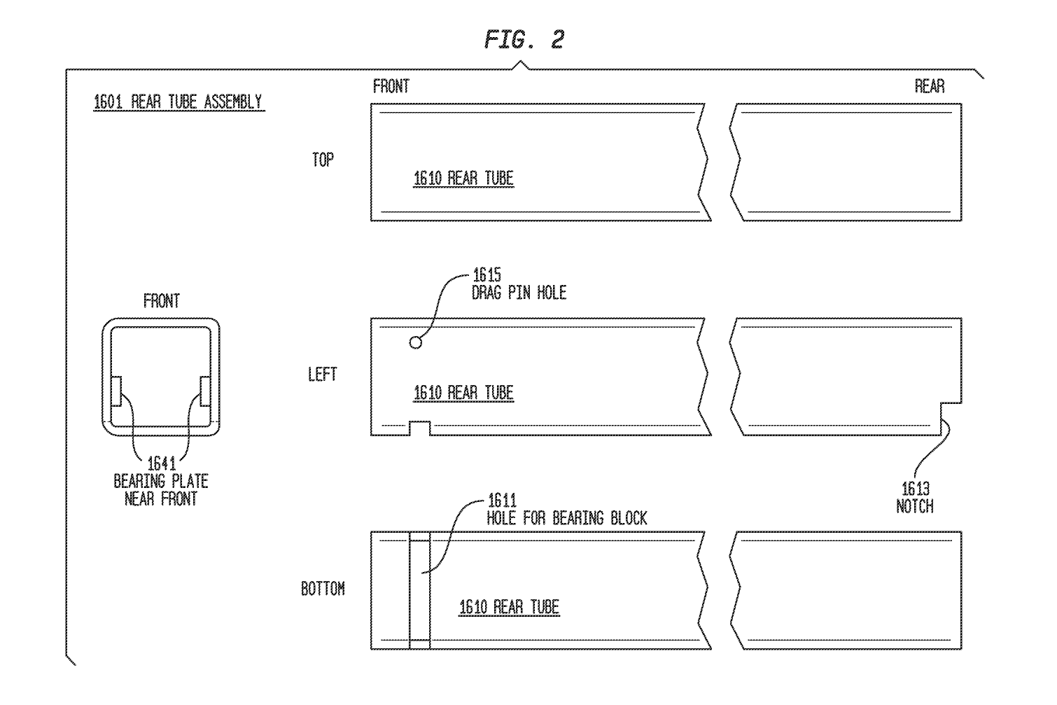

FIG. 2 illustrates front, left side, top, and bottom views of an embodiment of the rear tube assembly 1601 of the main beam 1600. The rear tube assembly 1601 comprises a rear tube 1610, along with bearing plates 1641 associated therewith. For ease of illustration, some hidden lines are not shown in FIG. 2. The illustrated rear tube 1610 has a generally rectangular cross section with rounded corners. While other cross sections shapes can be used, the rectangular shape can provide resistance to twisting, rotation, and torque forces. The rear tube 1610 can be made from A500 Grade B structural steel. In other embodiments, the rear tube 1610 (as well as other the other tubes) can be made from other materials such as aluminum or carbon fiber, as dictated by the load to be carried. In an exemplary embodiment made from A500 Grade B structural steel, the rear tube 1610 has a 6″×6″ cross section with 0.25″ thick walls, and is 8′ or more in length. In general, the material and cross-sectional dimensions of the rear tube 1610 are determined by the weight and dimensions of the load (e.g., an expandable component) that it is intended to carry. In general, the length of the rear tube 1610 will be limited by the dimension of the shelter in the direction of expansion/retraction of the telescopic support 1000. For example, for an 8′ wide shelter deploying a curbside expandable component, the length of a rear tube 1610 would be less than 8′.

The rear tube assembly 1601 can include two bearing plates 1641 positioned substantially symmetrically on the lower half of the left and right rear tube 1610 interior vertical walls. Sizing the bearing plates 1641 to cover substantially only the bottom half of the interior vertical walls can facilitate assembly of the main beam 1600, at least in part by allowing subsequent tube assemblies to be inserted from the front of the power telescopic support 1000. In an exemplary embodiment in which the rear tube 1610 has the above dimensions, each bearing plate 1641 is 3″ long by 5″ wide by 3/16″ thick. In some embodiments, each bearing plate 1641 is a single block of self-lubricating engineering plastic e.g., nylon plastic filled with lubricant powder. One example of such a material is Nylatron™ NSM, a nylon plastic filled with molybdenum disulfide lubricant powder. Solid lubricant additives impart self-lubricating, high pressure/velocity and superior wear resistance characteristics. In some embodiments of the power telescopic support 1000, each bearing plate 1641 is secured to the rear tube 1610 interior using four screws through holes (not shown) in the bearing plate 1641 to threaded holes in the interior wall of the rear tube 1610. The holes can be countersunk to allow the screw heads to sit below the surface of the bearing plate 1641 when installed.

The illustrated rear tube 1610 includes a notch 1613 at the lower rear to accommodate a feature of the shelter to which the power telescopic support 1000 attaches. Features such as the notch 1613 can be incorporated into embodiments of the technology to accommodate the form factor required for interfacing with the shelter in specific applications. Notch 1613 also can serve to transfer lateral force from a retracting telescopic support and load to certain portions of the shelter. FIG. 2 illustrates an drag pin hole 1615 near the front of rear tube 1610. In some embodiments of the technology, a threaded drag pin hole 1615 can be filled with a drag screw (not shown) that penetrates into the rear tube 1610 interior to engage a feature (described below) of the middle tube assembly 1602 to deter the middle tube 1620 from extending out of the rear tube 1610. Rear tube 1610 includes a hole 1611 in the bottom of the rear tube 1610 to accommodate a bearing block of a bearing assembly, described in detail below.

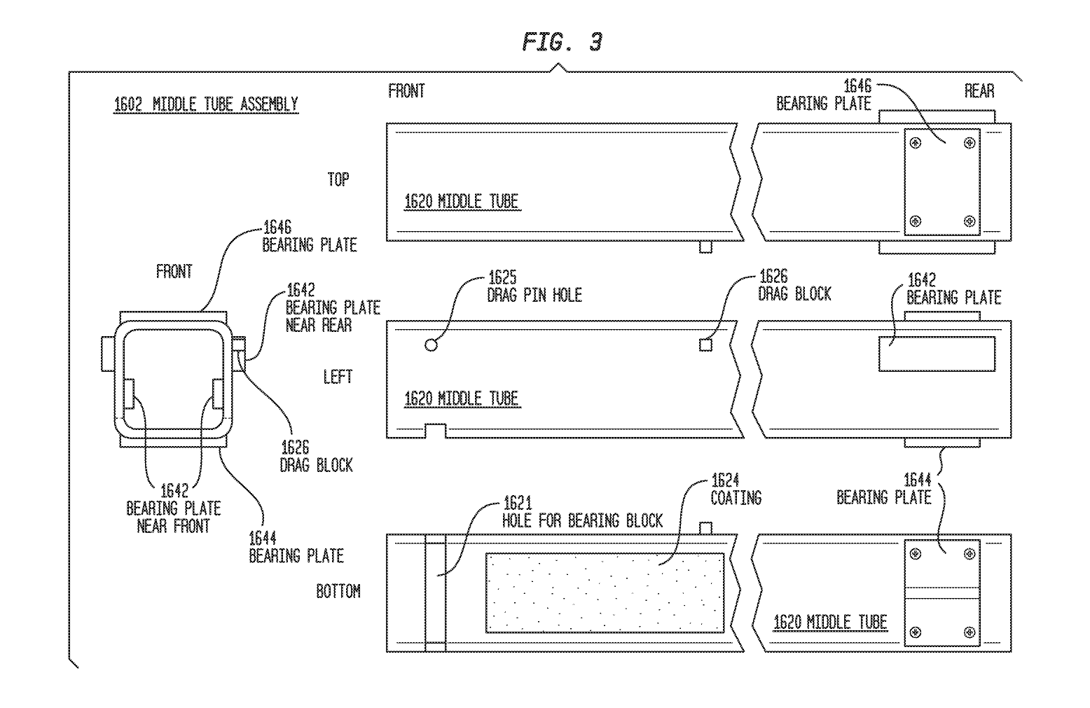

FIG. 3 illustrates front, left side, top, and bottom views of a middle tube assembly 1602 of the power telescopic support 1000. The middle tube assembly 1602 includes a middle tube 1620 and elements associated therewith as described below. For ease of illustration, some hidden lines are not shown in FIG. 3. There can be zero or more middle tubes assemblies 1602 in a power telescopic support 1000. For example, expandable components positioned at the front of a shelter are typically shorter than those intended for the curbside or roadside walls of the shelter. Such front-positioned expandable components can be supported on a telescopic support comprising only a rear tube assembly 1601 and a front tube assembly 1603. For other applications, e.g., a curbside expandable component extending more than 10′ from the shelter, more than one middle tube assembly 1602 can be used (in combination with an appropriately sized powering means such as a hydraulic cylinder, belt drive, or screw drive).

The illustrated middle tube 1620 has a generally rectangular cross section with rounded corners. Each subsequent middle tube 1620 is dimensioned to fit inside the next rear-most tube assembly, accounting for bearing plates of both tube assemblies. Like the rear tube 1610, the middle tube 1620 can be made from A500 Grade B structural steel and other materials. In an exemplary embodiment, the middle tube 1620 can have a 5″×5″ cross section with 0.25″ thick walls, and can be 8′ or more in length. As with the rear tube 1610, the cross-section dimensions of the middle tube 1620 are determined by the weight and dimensions of the load (e.g., an expandable component) that it is intended to carry. In general, the length of the middle tube 1620 will be limited by the dimension of the shelter in the direction of expansion/retraction of the power telescopic support 1000, accounting for the unretractable space created by more rearward tubes.

Each middle tube assembly 1602 can include two bearing plates 1642 positioned substantially symmetrically on the lower half of the left and right middle tube 1620 interior vertical walls. Sizing the bearing plates 1642 to cover substantially only the bottom half of the interior vertical walls of the middle tube 1620 can facilitate assembly of the telescopic support main assembly, at least in part by allowing subsequent tubes to be inserted from the front of the telescopic support. In addition, each middle tube assembly 1602 can include two bearing plates 1642 positioned substantially symmetrically on the upper half of the left and right tube exterior vertical walls. With respect to the rear tube assembly 1601, these bearing plates 1642 occupy the substantial portion of the space between the middle tube 1620 outer vertical wall and the rear tube 1610 inner vertical wall that is not occupied by the bearing plates 1641 described above.

In an exemplary embodiment, each bearing plate 1642 can be 3″ long by 5″ wide by 3/16″ thick. In some embodiments, each bearing plate 1642 is a single block of self-lubricating engineering plastic, e.g., nylon plastic filled with lubricant powder. One example of such a material is Nylatron™ NSM, a nylon plastic filled with molybdenum disulfide lubricant powder. Solid lubricant additives impart self-lubricating, high pressure/velocity and superior wear resistance characteristics. In some embodiments of the power telescopic support 1000, each bearing plate 1642 is secured to the middle tube 1620 interior using four screws through holes (not shown) in the bearing plate 1642 to threaded holes in the wall of the middle tube 1620. The bearing plate holes can be countersunk to allow the screw heads to sit below the surface of the bearing plate 1642 when installed.

Each middle tube assembly 1602 can include a bottom bearing plate 1644 positioned on the bottom surface of the middle tube 1620, near the rear of the middle tube 1620. Typically, each tube has a longitudinal weld seam along an interior surface. Typically each tube is oriented so that such a weld seam is on the bottom interior surface. Bearing plate 1644 can include a channel aligned with the tube longitudinal axis to account for the weld seam. Generally, bearing plates and other components of the main beam exposed to weld seams can be channeled in this fashion. Bearing plate 1644 is secured to the middle tube 1620 interior using four screws through holes (not shown) in the bearing plate 1644 to threaded holes in the wall of the middle tube 1620. The holes can be countersunk to allow the screw heads to sit below the surface of the bearing plate 1644 when installed. In some embodiments, each bearing plate 1644 is a single block of self-lubricating engineering plastic, e.g., nylon plastic filled with lubricant powder. One example of such a material is Nylatron™ NSM, a nylon plastic filled with molybdenum disulfide lubricant powder. Solid lubricant additives impart self-lubricating, high pressure/velocity and superior wear resistance characteristics.

Middle tube assembly 1602 includes a top bearing plate 1646 positioned at the exterior top wall of the middle tube 1620. Bearing plate 1646, and other bearing plates of the present technology, can be installed in a channel machined in the tube surface. In part, this approach can provide fastening strength. In an exemplary embodiment, each top bearing plate 1646 can be 2″ long by 4.625″ wide by ½″ thick with chamfered front and rear edges. In some embodiments, each top bearing plate 1646 is a single block of self-lubricating engineering plastic, e.g., nylon plastic filled with lubricant powder. One example of such a material is Nylatron™ NSM, a nylon plastic filled with molybdenum disulfide lubricant powder. Solid lubricant additives impart self-lubricating, high pressure/velocity and superior wear resistance characteristics. In some embodiments of the power telescopic support 1000, each top bearing plate 1646 is secured to the middle tube 1620 interior using four screws through holes (not shown) in the bearing plate 1646 to threaded holes in the wall of the middle tube 1620. The holes can be countersunk to allow the screw heads to sit below the surface of the top bearing plate 1646 when installed.

Each middle tube assembly 1602 can include an drag block 1626. Drag block 1626 is positioned on the outside of middle tube 1620 to engage a drag screw threaded through a drag pin hole in the next-rearward tube section. In the case of the illustrated embodiments, the next rearward tube section is the rear tube assembly 1601, and drag block is positioned to engage a screw threaded through drag pin hole 1615 in the rear tube 1610. This can deter the middle tube 1620 from extending out of the rear tube 1610. Each middle tube 1620 includes a drag pin hole 1625, similar to drag pin hole 1615, to hold a drag screw that can engage a drag block of the next-forward tube section, in part to ensure that the middle tube assembly 1602 will be extended from the rear tube assembly.

FIG. 3 illustrates a coating 1624 across a portion of the bottom of middle tube 1620. Coating 1624 can be a low-friction ceramic-filled abrasion resistant epoxy (e.g., Nordbak® 2-part ceramic filled epoxy). It can be applied to the bottom of the middle tube substantially along the portion of the bottom that will cross the front bottom edge of rear tube 1610 during extension and refraction of the power telescopic support 1000.

Middle tube assembly 1602 includes a hole 1621 in the bottom of the rear tube 1610 to accommodate a bearing block of a bearing assembly, described in detail below.

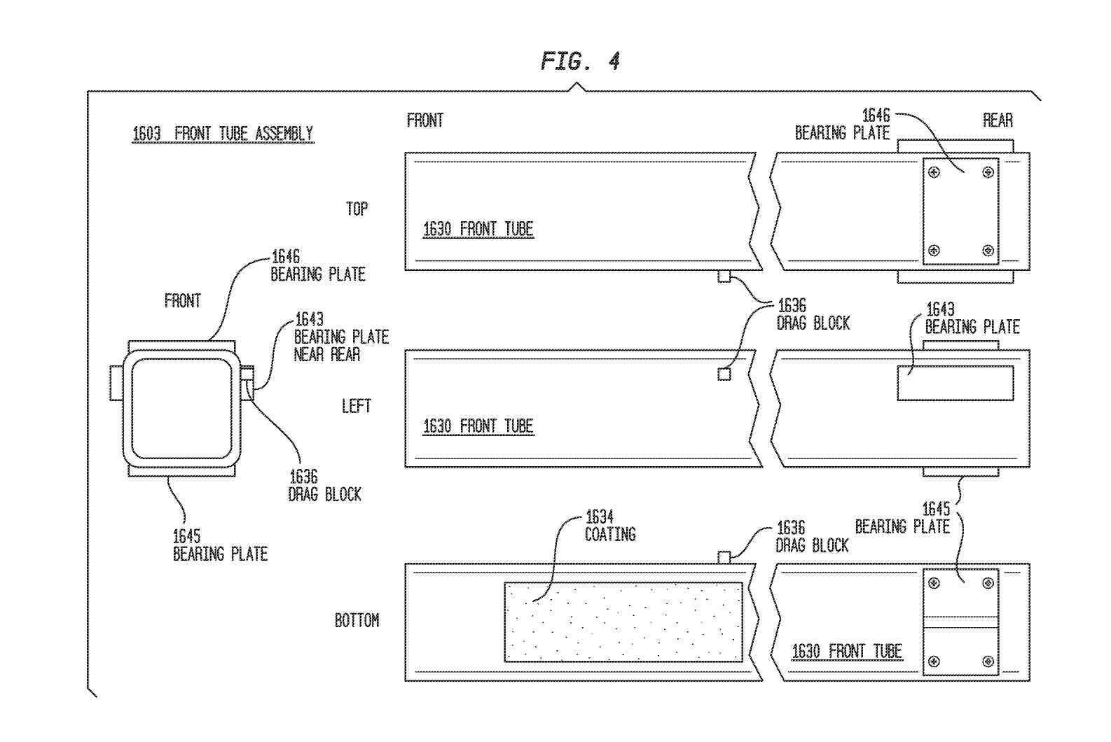

FIG. 4 illustrates front, left side, top, and bottom views of a front tube assembly 1603 of the power telescopic support 1000. The front tube assembly 1603 includes a front tube 1630 and elements associated therewith as described below. For ease of illustration, some hidden lines are not shown in FIG. 4. The illustrated front tube 1630 has a generally rectangular cross section with rounded corners. Each front tube assembly 1603 is dimensioned to fit inside the next rear-most tube, accounting for bearing plates of both tubes.

Like the rear tube 1610 and each middle tube 1620, the front tube 1630 can be made from A500 Grade B structural steel. In an exemplary embodiment, the front tube 1630 can have a 4″×4″ cross section with 0.375″ thick walls, and can be 8′ or more in length. As with the rear tube 1610 and the middle tube 1620, the cross-section dimensions of the front tube 1630 are determined by the weight and dimensions of the load (e.g., an expandable component) that it is intended to carry. In general, the length of the front tube 1630 will be limited by the dimension of the shelter in the direction of expansion/retraction of the telescopic support 1000, accounting for the unretractable space created by more rearward tubes.

Each front tube assembly 1603 can include two bearing plates 1643 positioned substantially symmetrically on the upper half of the left and right of the front tube 1630 exterior vertical walls. With respect to the next rearward tube assembly, e.g., a middle tube assembly 1602, these bearing plates 1643 occupy the substantial portion of the space between the front tube 1630 outer vertical wall and the middle tube 1620 inner vertical wall that is not occupied by the interior middle tube bearing plates 1642 described above.

In an exemplary embodiment, each bearing plate 1643 can be 3″ long by 5″ wide by 3/16″ thick. In some embodiments, each bearing plate 1643 is a single block of self-lubricating engineering plastic e.g., nylon plastic filled with lubricant powder. One example of such a material is Nylatron™ NSM, a nylon plastic filled with molybdenum disulfide lubricant powder. Solid lubricant additives impart self-lubricating, high pressure/velocity and superior wear resistance characteristics. In some embodiments of the power telescopic support 1000, each bearing plate 1643 is secured to the front tube 1630 interior using four screws through holes (not shown) in the bearing plate 1643 to threaded holes in the wall of the front tube 1630. The holes can be countersunk to allow the screw heads to sit below the surface of the bearing plate 1643 when installed.

Each front tube assembly 1603 can include a bottom bearing plate 1645 positioned on the bottom surface of the front tube 1630, near the rear of the front tube 1630. Typically, each tube has a longitudinal weld seam along an interior surface. Typically each tube is oriented so that such a weld seam is on the bottom interior surface. Bearing plate 1645 can include a channel aligned with the tube longitudinal axis to account for the weld seam. Bearing plate 1645 is secured to the front tube 1630 interior using four screws through holes (not shown) in the bearing plate 1645 to threaded holes in the wall of the front tube 1630. The holes can be countersunk to allow the screw heads to sit below the surface of the bearing plate 1645 when installed. In some embodiments, each bearing plate 1645 is a single block of self-lubricating engineering plastic, e.g., nylon plastic filled with lubricant powder. One example of such a material is Nylatron™ NSM, a nylon plastic filled with molybdenum disulfide lubricant powder. Solid lubricant additives impart self-lubricating, high pressure/velocity and superior wear resistance characteristics. Front tube assembly 1603 can include a top bearing plate 1646 positioned at the exterior top wall of the tube 1630, as described in connection with middle tube assembly 1602.

Each front tube assembly 1603 can include a drag block 1636. Drag block 1636 can be positioned on the outside of front tube 1630 to engage a drag screw threaded through a drag pin hole in the next-rearward tube assembly. In the case of the illustrated embodiments, the next rearward tube section is the middle tube assembly 1602, and drag block is positioned to engage a drag screw threaded through drag pin hole 1625 in the middle tube 1620. This can deter the front tube 1630 from extending out of the next rear-most tube, and can serve to “drag” the middle tube assembly 1602 out of the rear tube assembly 1601.

FIG. 4 illustrates a coating 1634 across a portion of the bottom of front tube 1630. Coating 1634 can be a low-friction ceramic-filled abrasion resistant epoxy (e.g., Nordbak® 2-part ceramic filled epoxy). It can be applied to the bottom of the middle tube substantially along the portion of the bottom that will cross the front bottom edge of next rear-most tube during extension and retraction of the power telescopic support 1000.

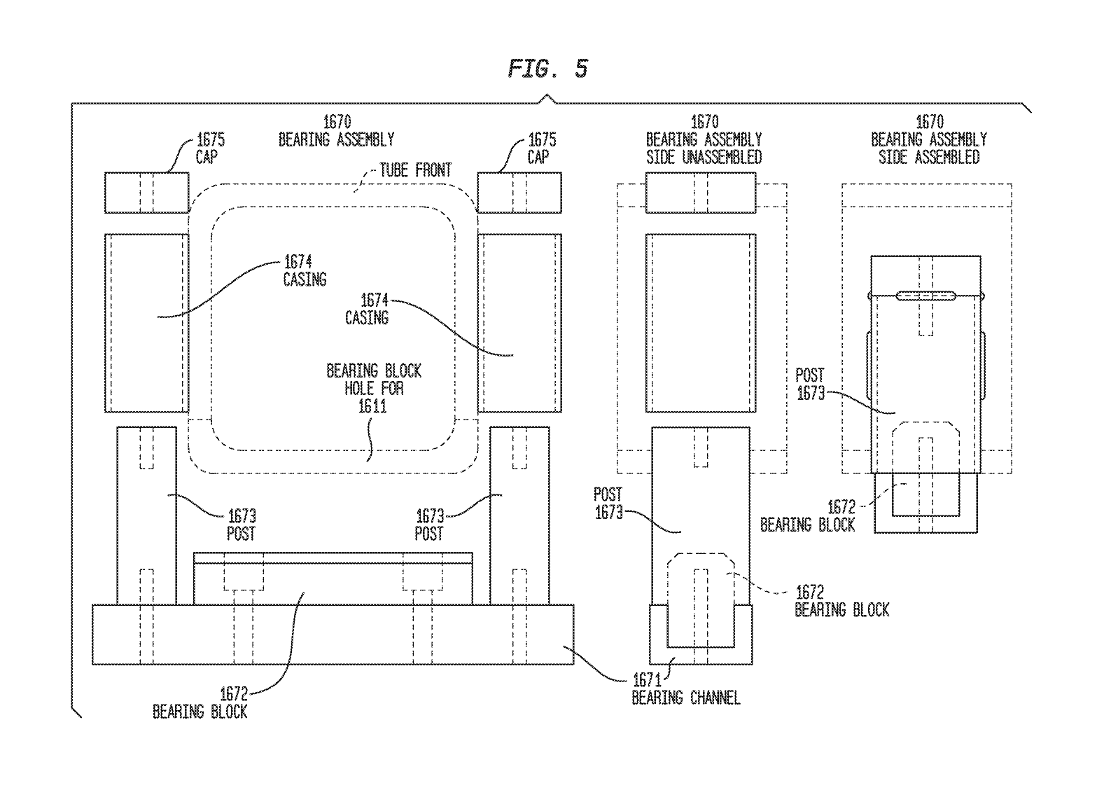

FIG. 5 illustrates a bearing assembly 1670 of a power telescopic support 1000 of the present technology. The bearing assembly 1670 includes a bearing channel 1671, a bearing block 1672, two bearing posts 1673, two casings 1674, two bearing caps 1675, and fasteners (not shown). In general, fasteners are not shown in this disclosure, and holes for the fasteners are shown as a notional diameter not necessarily representative of actual diameters that would be determined by one of skill in the relevant art based at least in part on specific materials and loads.

Bearing channel 1671 is generally U-shaped and can be machined from 2024 aluminum alloy used in aircraft structures and other aerospace applications. Bearing channel 1672 includes holes vertically from the bottom of the bearing channel 1671, preferably countersunk, for holding screws that mate with threaded holes in the bearing block 1672 and each post 1673.

Bearing block 1672 is generally rectangular with chamfered front and rear corners. In some embodiments, each bearing block 1672 can be a single block of self-lubricating engineering plastic, e.g., nylon plastic filled with lubricant powder, such as Nylatron™ NSM, a nylon plastic filled with molybdenum disulfide lubricant powder. In exemplary embodiments, bearing block is 1.5″ front to rear by 5″ left to right, by 1″ to fit into bearing channel 1672 and extend higher than the bearing channel 1671 by greater than the bottom wall thickness of a first tube, so as to engage the bottom surface the next forward tube through a hole in the bottom of the next forward tube.

Each post 1673 can be formed from steel, such as 1040 steel, and can have a horizontal cross section to fit in the channel of the bearing channel, and a height of approximately 2.5″. In the illustrated embodiment, each post 1673 includes a threaded hole in the bottom of the post 1673 for fastening the post to the bearing channel 1671, and a threaded hole in the top of the post 1673 for fastening the post to a bearing cap 1675. Other means of fastening each post 1673 to the bearing channel 1672 and fastening each post 1673 to a cap 1675 are known to those of skill in the relevant art.

Casing 1674 can be off-the-shelf stock A500 steel tube, and can be of cross section to accept a post 1673. For example, casing 1674 can be 2.5″×1.5″ in outer dimension with a 0.187″ thick wall. Each casing 1674 can be fastened to the rear tube 1610, e.g., by welding, with the casing 1674 vertical axis in longitudinal alignment with hole 1611.

Cap 1675 can be formed from steel, e.g., M1044 or 1045 hot rolled steel, and can be of cross section substantially equal to that of casing 1674. Cap 1675 includes a vertical through hole for a fastener to engage the threaded hole in the top of post 1673. Cap 1675 further includes horizontal and vertical set screw holes (not shown) that accommodate set screws for holding the bearing assembly in a set orientation after adjusting its height and position using fasteners, such as ⅝″ diameter hex cap screw, through the cap 1675 into the post 1673. Height adjustments using each of the vertically oriented screws in the bearing assembly 1670 can allow for leveling of the expandable component at deployment. Cap 1675 can be welded to the top of casing 1674.

More specifically, using the first bearing assembly 1670 and the overlap between the rear tube assembly 1601 and the middle tube assembly 1602 of FIG. 1 as an example (along with FIG. 5), bearing block 1672 and two posts 1673 are attached in bearing channel 1671 using screws inserted from the bottom of the bearing channel 1671 and mated to the corresponding threaded holes in the bearing block 1672 and each post 1673. A casing 1674 is welded to each side of rear tube assembly 1601 aligning each casing's vertical axis with the middle of hole 1611 in the bottom of rear tube 1610. The bearing channel 1671 with bearing block 1672 and two posts 1673 attached is inserted from the bottom of the rear tube 1610 so that each post is inserted into a casing 1674 and the bearing block 1672 is inserted into the hole 1611. A screw through the vertical hole in the cap 1675 is added to each post 1673 visible through the top of each casing 1674. The screws threaded into each post 1673 from both the top and the bottom are adjusted so that a proper amount of bearing block 1672 is exposed in the bottom interior of the rear tube 1610. Set screws are threaded into each cap 1675 to retain the position of the cap screws.

Given a rear tube assembly 1601 (e.g., as shown in FIG. 2) with a bearing assembly 1670 installed thereon, a next-forward middle tube assembly 1602 can be added to continue building the telescopic support main subassembly 1600. The rear end of a middle tube assembly 1602 (e.g., as shown in FIG. 3), can be inserted into the front end of the given rear tube assembly 1601, at least to the extent that the drag block 1626 of the middle tube assembly 1602 is inserted beyond the drag pin hole 1615 of the rear tube assembly 1601. A drag screw can be threaded into the drag pin hole 1615 of the rear tube 1610.

This process can be repeated with respect to the most recently installed tube assembly and its next-forward tube assembly, e.g., as between the middle tube assembly 1602 and a front tube assembly 1603. When the front tube assembly 1603 has been installed, the main sub assembly 1600 can be attached to the cylinder assembly using the elements identified in the discussion of FIG. 1.

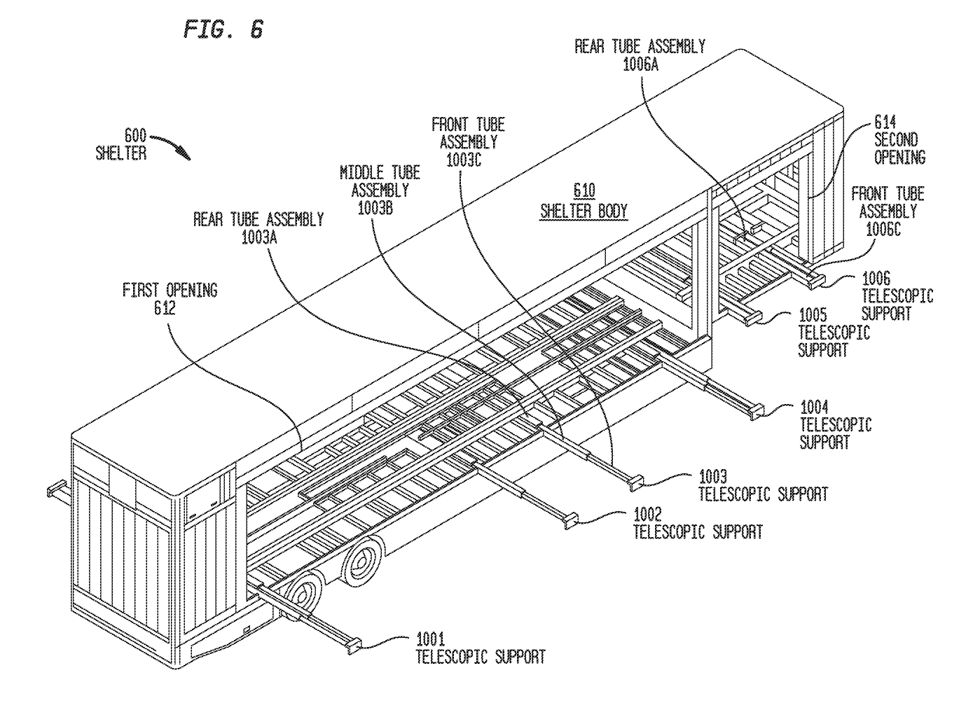

As noted above, one or more assembled telescopic supports can be added to a shelter to support an expandable component of the shelter. Referring to FIG. 6, a plurality of telescopic support assemblies 1001-1005 of the present technology applied to a shelter 600 configured as a fifth wheel trailer are illustrated. The shelter 600 includes a shelter body 610, that in the illustrated embodiment is a fifth wheel trailer comprising components typically found in such trailer including a chassis, body panels, signaling, braking, control, and communication components. The shelter body 610 is characterized by a shelter body perimeter, and the shelter body 610 defines therein a first opening 612 and a second opening 614—both on the curbside of the shelter.

The first opening 612 has associated therewith four (4) telescopic supports, 1001-1004. The second opening 614 has associated therewith two (2) telescopic supports, 1005 and 1006. Each telescopic support is shown in an extended configuration. Telescopic supports 1001, 1004, 1005 and 1006 are powered telescopic supports including a drive assembly such as a hydraulic cylinder subassembly to extend and retract the telescopic support. Telescopic supports 1002 and 1003 are not powered, and are extended and retracted by being tied to telescopic supports 1001 and 1004, e.g., by being attached to a common load such as a platform or an expandable component enclosure.

Telescopic supports 1001-1004 are shown as three-part tube assemblies, as illustrated with respect to tube assembly 1003. Tube assembly 1003 comprises rear tube assembly 1003A, a middle tube assembly 1003B, and front tube assembly 1003C.

Telescopic supports 1005 and 1006 are shown as two-part tube assemblies, as illustrated with respect to tube assembly 1006. Tube assembly 1006 comprises rear tube assembly 1006A and front tube assembly 1006C.

While various embodiments of the present technology have been described above, it should be understood that they have been presented by way of example only, and not limitation. For instance, the drive assembly, while illustrated in exemplary embodiments as hydraulic can be screw-driven (by power or hand crank), belt driven, or any other means for extending and retracting the telescopic support assembly. It will be apparent to persons skilled in the relevant art that various changes in form and detail can be made therein without departing from the spirit and scope of the technology. For instance, the expandable component supported by a telescopic beam assembly of the present technology can be a floor platform without a roof or walls extending from either of, or both of, a wall and an opening of a shelter. The expandable component supported by a telescopic beam assembly of the present technology can be an awning. The shelter illustrated in FIG. 6 can be an ISO shelter instead of a fifth-wheel trailer. Features described as part of one implementation can be used on another implementation to yield a still further implementation. Thus, the breadth and scope of the present technology should not be limited by any of the above-described exemplary embodiments, but should be defined only in accordance with the following claims and their equivalents.

What is claimed is:

1. A telescopic support assembly comprising:
a plurality of tube assemblies arranged telescopically from a largest cross section rear tube assembly to a smallest cross section front tube assembly; and
at least one bearing assembly comprising a non-roller bearing for each tube assembly other than the front tube assembly;
wherein each bearing assembly is configured to present a surface of the non-roller bearing at the bottom interior of the each tube assembly other than the front tube assembly, proximate the front of the each tube assembly other than the front tube assembly.

2. The telescopic support assembly of claim 1 wherein:
the at least one bearing assembly extends into the interior of each tube assembly other than the front tube assembly through a hole in the bottom of the each tube assembly other than the front tube assembly.

3. The telescopic support assembly of claim 1 wherein:
the non-roller bearing is a self-lubricating engineering plastic.

4. The telescopic support assembly of claim 3 wherein:
the self-lubricating engineering plastic is a nylon plastic containing a lubricant powder.

5. The telescopic support assembly of claim 4 wherein:
the lubricant powder is molybdenum disulfide.

6. The telescopic support of claim 1 wherein:
the telescopic support does not include roller bearings.

7. A telescopic support assembly comprising:
a main beam subassembly comprising:
a plurality of tube assemblies arranged telescopically from a largest cross section rear tube assembly to a smallest cross section front tube assembly; and
at least one bearing assembly comprising a non-roller bearing for each tube assembly other than the front tube assembly;
wherein each bearing assembly is configured to present a surface of the non-roller bearing at the bottom interior of the each tube assembly other than the front tube assembly, proximate the front of the each tube assembly other than the front tube assembly; and
a drive assembly operable to telescopically extend and retract the main subassembly.

8. The telescopic support assembly of claim 7 wherein:
the drive assembly is a powered drive assembly.

9. The telescopic support assembly of claim 8 wherein:
the drive assembly is hydraulically powered.

10. The telescopic support assembly of claim 7 wherein:
the at least one bearing assembly extends into the interior of each tube assembly other than the front tube assembly through a hole in the bottom of the each tube assembly other than the front tube assembly.

11. The telescopic support assembly of claim 7 wherein:
the non-roller bearing is a self-lubricating engineering plastic.

12. The telescopic support assembly of claim 11 wherein:
the self-lubricating engineering plastic is a nylon plastic containing a lubricant powder.

13. The telescopic support assembly of claim 12 wherein:
the lubricant powder is molybdenum disulfide.

14. The telescopic support of claim 7 wherein:
the telescopic support does not include roller bearings.

15. A shelter comprising:
a shelter body having a shelter body perimeter; and
at least one telescopic support assembly:
each telescopic support assembly comprising:
a plurality of tube assemblies arranged telescopically from a largest cross section rear tube assembly to a smallest cross section front tube assembly, and
at least one bearing assembly comprising a non-roller bearing for each tube assembly other than the front tube assembly,
wherein each bearing assembly is configured to present a surface of the non-roller bearing at the bottom interior of the each tube assembly other than the front tube assembly, proximate the front of the each tube assembly other than the front tube assembly;
each telescopic support assembly having a retracted configuration and a plurality of extended configurations; and
each telescopic support assembly attached to the shelter such that in at least one of the plurality of extended configurations, the each telescopic support assembly extends beyond the shelter body perimeter.

16. The telescopic support assembly of claim 15 wherein:
the at least one bearing assembly extends into the interior of each tube assembly other than the front tube assembly through a hole in the bottom of the each tube assembly other than the front tube assembly.

17. The telescopic support assembly of claim 15 wherein:
the non-roller bearing is a self-lubricating engineering plastic.

18. The telescopic support assembly of claim 17 wherein:
the self-lubricating engineering plastic is a nylon plastic containing a lubricant powder.

19. The telescopic support assembly of claim 18 wherein:
the lubricant powder is molybdenum disulfide.

20. The telescopic support of claim 15 wherein:
the telescopic support does not include roller bearings.

21. The telescopic support assembly of claim 15 wherein:
the drive assembly is a powered drive assembly.

22. The telescopic support assembly of claim 21 wherein:
the drive assembly is hydraulically powered.
